(19) United States
(12) Patent Application Publication
(10) Pub. No.: US 2026/0309112 A1
(43) Pub. Date: Oct. 8, 2026

(54) IGNITION DEVICE AND INTERNAL COMBUSTION ENGINE

(71) Applicant: TOYOTA JIDOSHA KABUSHIKI KAISHA, Toyota-shi (JP)

(72) Inventors: Yusuke KATO, Okazaki-shi (JP); Akira KAMADA, Toyota-shi (JP); Yuta TAJIMA, Nagoya-shi (JP)

(73) Assignee: TOYOTA JIDOSHA KABUSHIKI KAISHA, Toyota-shi (JP)

(21) Appl. No.: 19/550,698

(22) Filed: Feb. 26, 2026

(30) Foreign Application Priority Data
Apr. 4, 2025 (JP) 2025-062460

(51) Int. Cl. F02P 15/00

(52) U.S. Cl. CPC F02P 15/00

(57) ABSTRACT

The ignition device is attached to a cylinder head of an internal combustion engine in which an air flow flowing from an intake port side toward an exhaust port side along a ceiling surface of the combustion chamber is formed. The ignition device includes a housing, a center electrode, a ground electrode, and a wall portion. The wall portion serves as a barrier against the air flow flowing from the outside toward the discharge gap in the radial direction of the center electrode. The ignition device is attached to the cylinder head in a direction in which the wall portion is located between the intake port and the discharge gap in the radial direction of the center electrode.

### CROSS-REFERENCE TO RELATED APPLICATION

This application claims priority to Japanese Patent Application No. 2025-062460 filed on Apr. 4, 2025. The disclosure of the above-identified application, including the specification, drawings, and claims, is incorporated by reference herein in its entirety.

### BACKGROUND

### 1. Technical Field

The present disclosure relates to an ignition device and an internal combustion engine.

### 2. Description of Related Art

Japanese Unexamined Patent Application Publication No. 2015-175318 (JP 2015-175318 A) discloses a spark-ignition internal combustion engine provided with an air flow guide member that changes the direction of an air flow passing through a discharge gap at the time of ignition, in order to suppress a flame kernel generated from a discharge spark of an ignition plug touching a ceiling of a combustion chamber. The air flow guide member guides the air flow in the combustion chamber toward a discharge gap between a ground electrode and a center electrode.

### SUMMARY

Since the air flow in the combustion chamber flows along the air flow guide member and is guided toward the discharge gap, the flow velocity of the air flow passing through the discharge gap increases. When the flow velocity of the air flow passing through the discharge gap becomes too high, the flame kernel generated by the discharge in the discharge gap may be extinguished by the air flow, resulting in a misfire.

In view of the above, a first aspect of the present disclosure provides an ignition device attached to a cylinder head of an internal combustion engine in which an air flow flowing from a side of an intake port toward a side of an exhaust port along a ceiling surface of a combustion chamber is generated, the ignition device including: a housing; an insulator held in the housing; a center electrode that protrudes from a tip of the insulator; a ground electrode that faces the center electrode via a discharge gap in an axial direction of the center electrode; and a wall portion that is provided at a tip of the housing and serves as a barrier to the air flow flowing from outside toward the discharge gap in a radial direction of the center electrode, in which the ignition device is attached to the cylinder head in such a direction that the wall portion is positioned between the intake port and the discharge gap in the radial direction of the center electrode.

In view of the above, a second aspect of the present disclosure provides an internal combustion engine in which

an intake valve that opens and closes an intake port, an exhaust valve that opens and closes an exhaust port, and an ignition device are attached to a cylinder head, and an air flow flowing from a side of the intake port toward a side of the exhaust port along a ceiling surface of a combustion chamber is generated, in which:

the ignition device

is disposed between the intake port and the exhaust port, and

includes a housing, an insulator held in the housing, a center electrode that protrudes from a tip of the insulator, and a ground electrode that faces the center electrode via a discharge gap in an axial direction of the center electrode;

the ground electrode includes a facing portion that faces the center electrode in the axial direction, and a support portion that extends from a tip of the housing to support the facing portion;

the internal combustion engine includes a wall portion provided between the intake port and the center electrode in the cylinder head to serve as a barrier to the air flow flowing toward the discharge gap; and

a first straight line passing through a centroid of the wall portion and a central axis of the center electrode and a second straight line passing through a centroid of the support portion and the central axis are orthogonal to each other when viewed in the axial direction of the center electrode.

According to the above ignition device and the above internal combustion engine, it is possible to reduce the risk of a misfire caused by a flame kernel being extinguished by an air flow.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a structure of a combustion chamber of an internal combustion engine including an ignition device according to a first embodiment;

FIG. 2 is a cross-sectional view showing the ignition device shown in FIG. 1;

FIG. 3 is a cross-sectional view showing a discharge gap of the ignition device shown in FIG. 2;

FIG. 4 is a cross-sectional view taken along IV-IV line of FIG. 3;

FIG. 5 is a cross-sectional view showing the internal combustion engine of the second embodiment; and

FIG. 6 is a cross-sectional view taken along VI-VI line of FIG. 5.

### DETAILED DESCRIPTION OF EMBODIMENTS

### First Embodiment

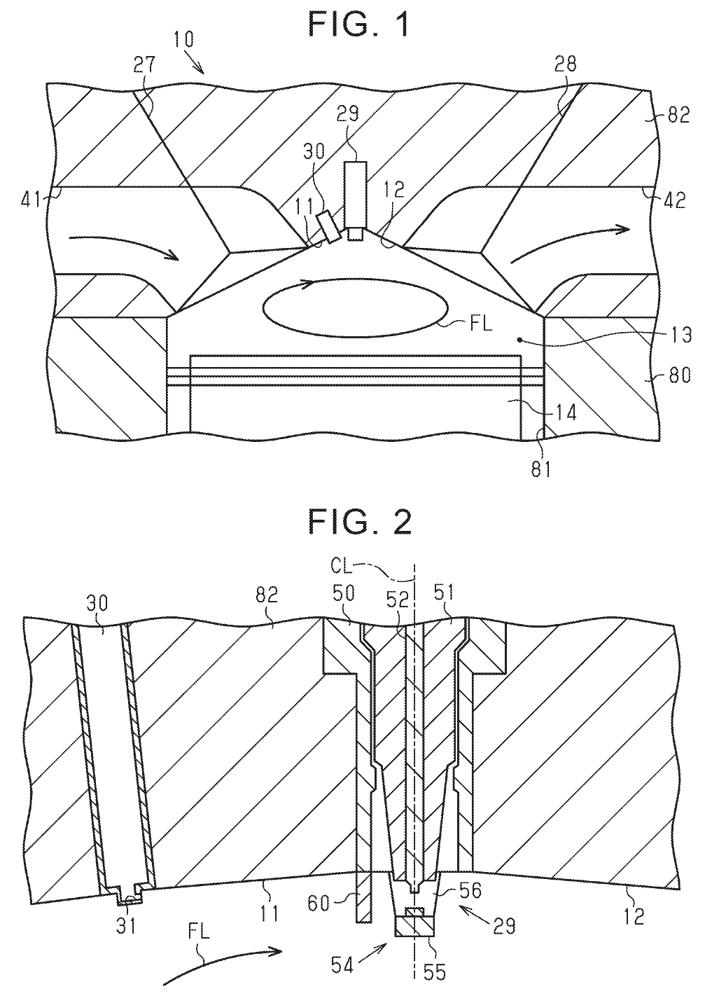

Hereinafter, a first embodiment of an ignition device will be described with reference to FIGS. 1-4.

### Internal combustion engine 10

As shown in FIG. 1, the internal combustion engine 10 provided with the ignition device 29 has a cylinder block 80. The cylinder block 80 is provided with a cylinder 81. A piston 14 is accommodated in the cylinder 81 so as to be reciprocable. A cylinder head 82 is connected to an upper end of the cylinder block 80.

The internal combustion engine 10 is provided with a combustion chamber 13 constituted by a cylinder 81, a piston 14, and a cylinder head 82. Two roofs 11 and 12 are formed in the cylinder head 82. The wall surfaces of the roofs 11 and 12 function as a ceiling surface of the combustion chamber 13. That is, the internal combustion engine 10 includes a pentroof-type combustion chamber 13. The cylinder head 82 is provided with an intake port 41 for introducing intake air into the combustion chamber 13 and an exhaust port 42 for discharging exhaust air from the combustion chamber 13. The intake port 41 is provided with an intake valve 27 that opens and closes the intake port 41 with respect to the combustion chamber 13. The intake valve 27 is provided on the roof 11 side. The exhaust port 42 is provided with an exhaust valve 28 that opens and closes the exhaust port 42 with respect to the combustion chamber 13. The exhaust valve 28 is provided on the roof 12 side.

When the intake air flows into the combustion chamber 13 from the intake port 41, as indicated by arrows in FIGS. 1-6, an air flow FL flowing from the intake port 41 side toward the exhaust port 42 side along the ceiling surface of the combustion chamber 13 is formed. The air flow FL is, for example, a tumble flow.

The internal combustion engine 10 includes an ignition device 29. The ignition device 29 is disposed between the intake port 41 and the exhaust port 42 in the cylinder head 82. Specifically, the ignition device 29 is provided at the top of the combustion chamber 13 where the roof 11 and the roof 12 intersect.

The internal combustion engine 10 includes a fuel injection valve 30 that injects fuel directly into the combustion chamber 13. The fuel injection valve 30 is an in-cylinder injection valve. The fuel injection valve 30 is provided between the ignition device 29 in the roof 11 and the intake port 41. The internal combustion engine 10 may include a port injection valve that injects fuel into the intake port 41 as the fuel injection valve 30.

The air-fuel mixture containing the fuel injected from the fuel injection valve 30 and the air introduced into the combustion chamber 13 from the intake port 41 along with the opening of the intake valve 27 is ignited by the spark discharge of the ignition device 29 and burns. The air-fuel mixture combusted in the combustion chamber 13 is exhausted and discharged to the exhaust port 42 as the exhaust valve 28 is opened.

### Ignition device 29

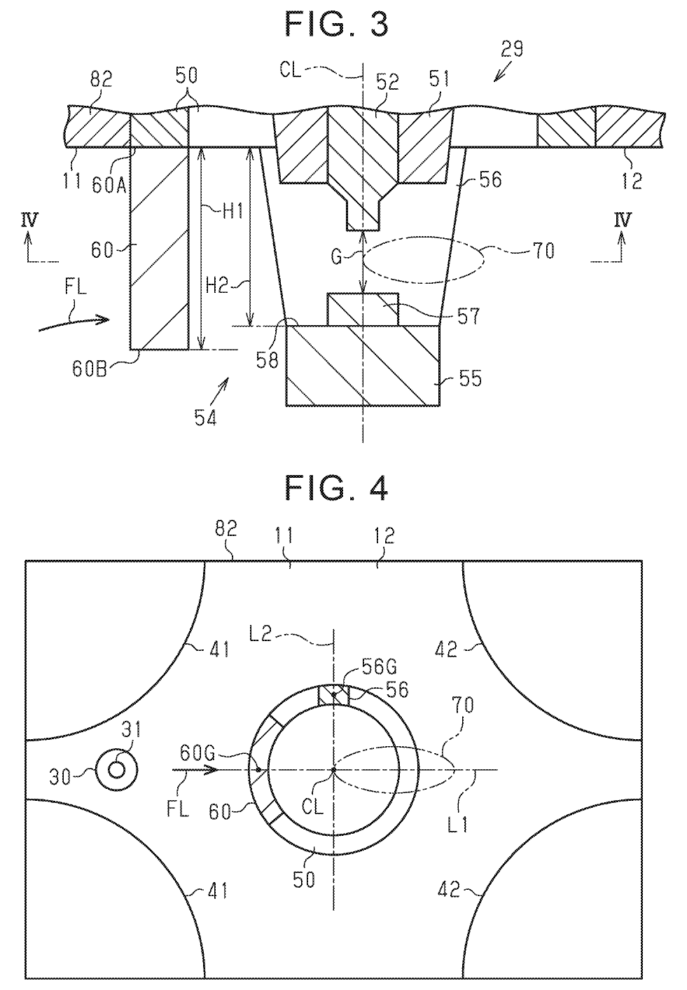

FIG. 2 shows a cross-sectional view of the ignition device 29. FIG. 3 is a cross-sectional view around the ground electrode 54 shown in FIG. 2. As illustrated in FIGS. 2 and 3, the ignition device 29 includes a housing 50, an insulator 51, a center electrode 52, a ground electrode 54, and a wall portion 60. The housing 50 is made of metal. The insulator 51 is made of ceramic. The insulator 51 is incorporated into the housing 50 so as to penetrate the inside of the cylindrical housing 50. The insulator 51 is held in the housing 50.

The center electrode 52 is made of metal. The center electrode 52 is incorporated in the insulator 51. The center electrode 52 protrudes from the tip of the insulator 51. That is, the center electrode 52 is exposed from one end of the insulator 51 and is disposed in the combustion chamber 13.

The ground electrode 54 is opposed to the center electrode 52 via the discharge gap G in the axial direction of the center axis CL indicated by the chain line of the center electrode 52. The ground electrode 54 includes a facing portion 55 and a support portion 56. The facing portion 55 faces the center electrode 52 in the axial direction. The support portion 56 extends from the tip of the housing 50 and supports the facing portion 55.

The fuel injection valve 30 injects fuel from the injection port 31. The fuel is injected from the injection port 31 along the flow of the air flow FL. As shown in FIG. 3, a ground electrode tip 57 is provided on a surface 58 of the ground electrode 54 facing the center electrode 52. When a high voltage is applied to the center electrode 52, a spark discharge occurs in the discharge gap G between the center electrode 52 and the ground electrode tip 57. The ignition of the air-fuel mixture by the spark discharge generates a flame kernel 70 indicated by a two-dot chain line.

The wall portion 60 is provided at a tip of the housing 50 on the side of the combustion chamber 13. The wall portion 60 serves as a barrier against the air flow FL flowing from the outer side toward the discharge gap G in the radial direction of the center electrode 52.

As shown in FIG. 3, the height H1 of the wall portion 60 is equal to or greater than the height H2 of the surface 58 of the ground electrode 54 facing the center electrode 52. The height H1 is a length from the proximal end 60A of the wall portion 60 to an axially rising distal end 60B of the center electrode 52. The proximal end 60A is located at a tip of the housing 50 closer to the combustion chamber 13. The height H2 is a length from the tip of the housing 50 toward the combustion chamber 13 to the surface 58.

FIG. 4 is a cross-sectional view taken along IV-IV line of FIG. 3. As illustrated in FIG. 4, the ignition device 29 is attached to the cylinder head 82 in a direction in which the wall portion 60 is positioned between the intake port 41 and the discharge gap G in the radial direction of the center electrode 52. In the housing 50, for example, a screw for attaching the ignition device 29 to the cylinder head 82 is designed such that the attachment angle of the ignition device 29 is a target angle.

As shown in FIG. 4, when the center electrode 52 is viewed in the axial direction, a straight line passing through the centroid 60G and the central axis CL of the wall portion 60 is defined as a first straight line L1, and a straight line passing through the centroid 56G and the central axis CL of the support portion 56 is defined as a second straight line L2, the first straight line L1 and the second straight line L2 are perpendicular to each other. The support portion 56 is provided at a position that does not intersect the first straight line L1.

### Operation of the first embodiment

As shown in FIG. 4, the wall portion 60 located between the intake port 41 and the discharge gap G suppresses FL of the air flow flowing toward the discharge gap G. Therefore, when the wall portion 60 is provided, the flow velocity of the air flow FL passing through the discharge gap G becomes slower than when the wall portion 60 is not provided.

### Effect of the 1 embodiment

### 1-1

According to the ignition device 29 of the internal combustion engine 10, it is possible to reduce the risk of misfire caused by the flame kernel 70 being blown out by the air flow FL.

### 1-2

As shown in FIG. 3, the height H1 of the wall portion 60 is equal to or greater than the height H2 of the surface 58 of the ground electrode 54 facing the center electrode 52. The wall portion 60 has a height H1 that shields the entire discharge gap G in which spark discharge occurs when viewed from the radially outer side of the center electrode 52. According to the ignition device 29 of the internal combustion engine 10, it is possible to effectively block the air flow FL toward the discharge gap G.

### 1-3

As illustrated in FIG. 3, the ground electrode 54 includes a facing portion 55 and a support portion 56. The facing portion 55 faces the center electrode 52 in the axial direction of the center electrode 52. The support portion 56 extends from the tip of the housing 50 and supports the facing portion 55.

As shown in FIG. 4, the support portion 56 does not intersect the first straight line L1 when the center electrode 52 is viewed in the axial direction. The air flow FL flowing around the wall portion 60 passes through the discharge gap G located downstream. The flame kernel 70 generated by the spark-discharge extends toward the flow of the air flow FL. When there is a support portion 56 at the extended end of the flame kernel 70, the flame kernel 70 may contact the support portion 56. When the flame kernel 70 comes into contact with the support portion 56, heat of the flame kernel 70 may be taken away by the support portion 56, resulting in misfire.

As shown in FIG. 3, the discharge gap G is located on the central axis CL of the center electrode 52. Therefore, the air flow FL flowing around the wall portion 60 and passing through the discharge gap G flows in the direction of the first straight line L1 shown in FIG. 4 when viewed in the axial direction. The flame kernel 70 generated in the discharge gap G extends in the direction in which the air flow FL flows. That is, the flame kernel 70 easily extends along the first straight line L1. The support portion 56 is provided at a position that does not intersect the first straight line L1. Therefore, in the internal combustion engine 10 to which the ignition device 29 is attached, the flame kernel 70 extending downstream along the air flow FL hardly contacts the support portion 56. According to the ignition device 29 of the internal combustion engine 10, it is possible to reduce the risk of misfire caused by the contact between the support portion 56 of the ground electrode 54 and the flame kernel 70.

### 1-4

As shown in FIG. 4, in the ignition device 29, the second straight line L2 and the first straight line L1 are perpendicular to each other as viewed in the axial direction of the center electrode 52. The larger the deviation between the direction in which the flame kernel 70 extends from the center electrode 52 along the air flow FL and the direction from the central axis CL of the center electrode 52 toward the centroid 56G of the support portion 56 is, the lower the possibility that the flame kernel 70 and the support portion 56 come into contact with each other can be reduced. On the other hand, when the support portion 56 is located closer to the wall portion 60 than the discharge gap G, the air flow FL flowing toward the discharge gap G is blocked by the support portion 56 in addition to the wall portion 60. In this case, the air flow FL flowing into the discharge gap G is disturbed, and thus there is a possibility that the flame kernel 70 is less likely to be generated.

The air flow FL passing through the discharge gap G flows along the first straight line L1. Therefore, when the support portion 56 is provided at a position where the first straight line L1 and the second straight line L2 are perpendicular to each other, the air flow FL prior to flowing into the discharge gap G is less likely to be blocked by the support portion 56. According to the ignition device 29 in which the first straight line L1 and the second straight line L2 are perpendicular to each other, it is possible to make it difficult to disturb the air flow FL flowing into the discharge gap G while reducing the risk of misfire.

### Modification of the first embodiment

For example, the support portion 56 may be provided downstream of the discharge gap G in the air flow FL in the axial view of the center electrode 52. Here, the first straight line L1 and the second straight line L2 are not perpendicular to each other. That is, the first straight line L1 and the second straight line L2 may not be perpendicular to each other. When the support portion 56 is provided at a position that does not intersect the first straight line L1 even when the first straight line L2 and the second straight line OOC are not perpendicular to each other, the ignition device 29 achieves the advantages shown in 1-1 to 1-3.

In the ignition device 29, the ground electrode 54 may be provided such that the support portion 56 intersects the first straight line L1 when the center electrode 52 is viewed in the axial direction. Even in this case, when the wall portion 60 located between the intake valve 27 and the discharge gap G is provided, the ignition device 29 has the effects shown in 1-1 and 1-2.

The optimum height H1 of the wall portion 60 to reduce the risk of misfire may be determined experimentally. That is, the height H1 of the wall portion 60 can be changed as appropriate. The height H1 of the wall portion 60 may be, for example, less than the height H2.

### Second Embodiment

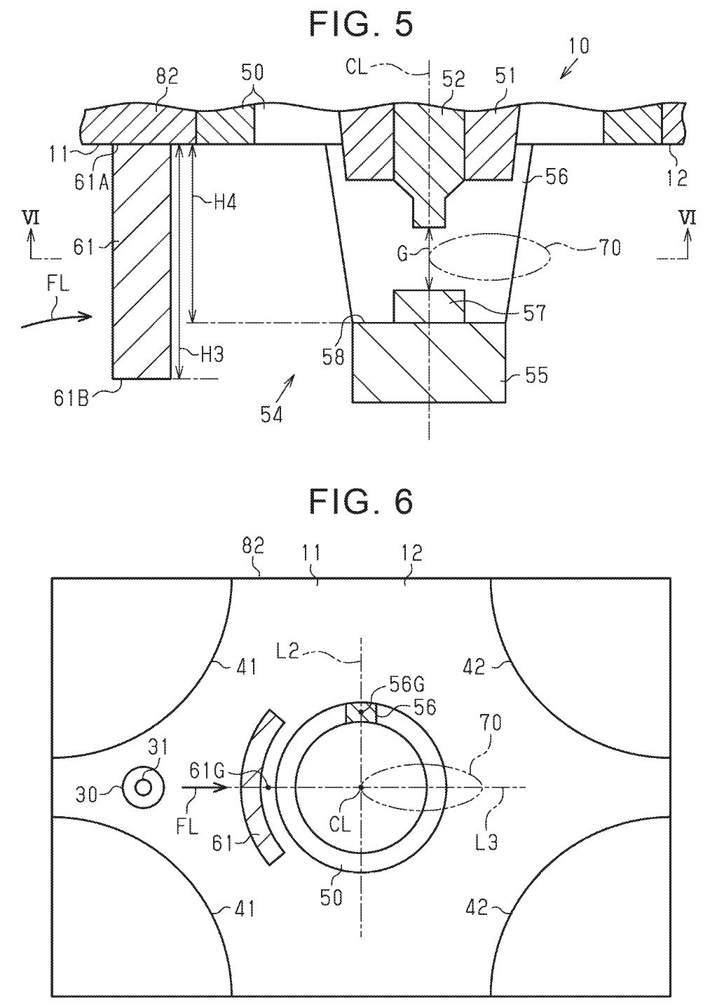

Hereinafter, a second embodiment, which is an embodiment of an internal combustion engine, will be described with reference to FIGS. 5 and 6. The second embodiment will be described mainly with respect to differences from the configuration described with reference to FIGS. 1-4.

As shown in FIG. 5, in the internal combustion engine 10 of the second embodiment, a wall portion 61 serving as a barrier against FL of the air flow flowing toward the discharge gap G is provided between the intake port 41 and the center electrode 52 in the cylinder head 82. The wall portion 61 has the same function as the wall portion 60 in the ignition device 29 of the first embodiment. The configuration of the internal combustion engine 10 of the second embodiment is the same except that a configuration in which the wall portion 61 is provided in the cylinder head 82 is adopted instead of the configuration in which the wall portion 60 is provided in the ignition device 29.

As shown in FIG. 5, the height H3 of the wall portion 61 is equal to or greater than the height H4 of the surface 58 of the ground electrode 54 facing the center electrode 52. The height H3 is a length from the proximal end 61A of the wall portion 61 to the distal end 61B of the center electrode 52. The proximal end 61A is located on the roof 11. The height H4 is a length from the proximal end 61A on the roof 11 to the surface 58.

FIG. 6 is a cross-sectional view taken along VI-VI line of FIG. 5. As shown in FIG. 6, in the axial view of the center electrode 52, a straight line passing through the centroid 61G and the central axis CL of the wall portion 61 is defined as a first straight line L3, and a straight line passing through the centroid 56G and the central axis CL of the support portion 56 is defined as a second straight line L2. The ignition device 29 is mounted on the internal combustion engine 10 such that the first straight line L3 and the second straight line L2 are perpendicular to each other.

### Operation of the second embodiment

Even when the cylinder head 82 is provided with the wall portion 61 that suppresses the air flow FL flowing toward the discharge gap G, the flow velocity of the air flow FL blown toward the flame kernel 70 generated in the discharge gap G becomes slow.

The air flow FL passing through the discharge gap G flows along the first straight line L3. Therefore, when the wall portion 61 and the support portion 56 are provided at positions where the first straight line L3 and the second straight line L2 are perpendicular to each other, the flame kernel 70 extending downstream by the air flow FL hardly contacts the support portion 56.

The larger the deviation between the direction in which the flame kernel 70 extends from the center electrode 52 along the air flow FL and the direction from the central axis CL of the center electrode 52 toward the centroid 56G of the support portion 56 is, the lower the possibility that the flame kernel 70 and the support portion 56 come into contact with each other can be reduced. On the other hand, when the support portion 56 is located closer to the wall portion 61 than the discharge gap G, the air flow FL flowing toward the discharge gap G is blocked by the support portion 56 in addition to the wall portion 61. In this case, the air flow FL flowing into the discharge gap G is disturbed, and thus there is a possibility that the flame kernel 70 is less likely to be generated. When the wall portion 61 and the support portion 56 are provided at positions where the first straight line L3 and the second straight line L2 are perpendicular to each other, the air flow FL prior to flowing into the discharge gap G is less likely to be blocked by the support portion 56. That is, according to the internal combustion engine 10 in which the first straight line L3 and the second straight line L2 are perpendicular to each other, it is possible to make it difficult to disturb the air flow FL flowing into the discharge gap G while reducing the risk of misfire.

### Effect of the 2 embodiment

According to the configuration of the second embodiment, effects similar to those of the first embodiment 1-1 to 1-4 can be obtained.

### Modification of the second embodiment

The optimum height H3 of the wall portion 61 to reduce the risk of misfire may be determined experimentally. That is, the height H3 of the wall portion 61 can be changed as appropriate. The height H3 of the wall portion 61 may be, for example, less than the height H4.

What is claimed is:

1. An ignition device attached to a cylinder head of an internal combustion engine in which an air flow flowing from a side of an intake port toward a side of an exhaust port along a ceiling surface of a combustion chamber is generated, the ignition device comprising:
a housing; an insulator held in the housing; a center electrode that protrudes from a tip of the insulator; a ground electrode that faces the center electrode via a discharge gap in an axial direction of the center electrode; and a wall portion that is provided at a tip of the housing and serves as a barrier to the air flow flowing from outside toward the discharge gap in a radial direction of the center electrode, wherein
the ignition device is attached to the cylinder head in such a direction that the wall portion is positioned between the intake port and the discharge gap in the radial direction of the center electrode.

2. The ignition device according to claim 1, wherein a height of the wall portion is equal to or greater than a height of a surface of the ground electrode that faces the center electrode.

3. The ignition device according to claim 1, wherein:
the ground electrode includes
a facing portion that faces the center electrode in the axial direction of the center electrode, and
a support portion that extends from the tip of the housing to support the facing portion; and
the support portion does not intersect a straight line passing through a centroid of the wall portion and a central axis of the center electrode when viewed in the axial direction of the center electrode.

4. The ignition device according to claim 3, wherein
when the straight line passing through the centroid of the wall portion and the central axis is defined as a first straight line,
the first straight line and a second straight line passing through a centroid of the support portion and the central axis are orthogonal to each other when viewed in the axial direction.

5. An internal combustion engine in which an intake valve that opens and closes an intake port, an exhaust valve that opens and closes an exhaust port, and an ignition device are attached to a cylinder head, and an air flow flowing from a side of the intake port toward a side of the exhaust port along a ceiling surface of a combustion chamber is generated, wherein:
the ignition device
is disposed between the intake port and the exhaust port, and
includes a housing, an insulator held in the housing, a center electrode that protrudes from a tip of the insulator, and a ground electrode that faces the center electrode via a discharge gap in an axial direction of the center electrode;
the ground electrode includes a facing portion that faces the center electrode in the axial direction, and a support portion that extends from a tip of the housing to support the facing portion;
the internal combustion engine includes a wall portion provided between the intake port and the center electrode in the cylinder head to serve as a barrier to the air flow flowing toward the discharge gap; and
a first straight line passing through a centroid of the wall portion and a central axis of the center electrode and a second straight line passing through a centroid of the support portion and the central axis are orthogonal to each other when viewed in the axial direction of the center electrode.
